(19) United States
(12) Patent Application Publication
(10) Pub. No.: US 2012/0168597 A1
(43) Pub. Date: Jul. 5, 2012

(54) Portable Stand For General Purpose Use

(75) Inventor: Lional Fredrick Hendrix, Osceola, AR (US)

(73) Assignee: Lional Fredrick Hendrix, JR., Osceola, AR (US)

(21) Appl. No.: 13/339,895

(22) Filed: Dec. 29, 2011

Related U.S. Application Data
(60) Provisional application No. 61/428,507, filed on Dec. 30, 2010.

(51) Int. Cl. F16M 11/04; F16M 11/22

(52) U.S. Cl. 248/523; 248/127

(57) ABSTRACT

A portable stand designed to be used with standard 2-inch diameter polyvinyl chloride (PVC) pipe and fittings that can be configured to accommodate a number of general purpose uses. The portable stand is a hollow plastic shell, which resembles an upside down bucket. The diameter of the circular base is slightly larger than the diameter of the circular top. The circular top has two openings One opening in the center of the circular top is configured to be a socket for a standard 2-inch diameter PVC pipe stand-post. A second, smaller opening has a plug that can be removed to fill the hollow shell with sand when needed to provide additional weight and better stability for the portable stand.

### CROSS REFERENCES TO RELATED APPLICATIONS AND U.S. PATENT DOCUMENTS

This application is a continuation of provisional patent application No. 61/428,507, filed in the United States Patent Office on Dec. 30, 2010.

The following U.S. patent documents are referenced in the specification section, herein:

| | | | |
|---|---|---|---|
| 4,343,449 | August 1982 | Osthus | 248/156 |
| 4,777,750 | October 1988 | Garfinkle | 40/607 |
| 5,220,740 | June 1993 | Brault | 40/606 |
| 5,875,578 | March 1999 | Grewe | 40/608 |
| 5,878,518 | March 1999 | Grewe | 40/606 |
| 7,140,581 | November 2006 | White | 248/129 |

### BACKGROUND OF THE INVENTION

The invention relates to a portable base or stand that is designed for general purpose use, as compared to a stand that is designed for a specific use.

U.S. Pat. Nos. 4,343,449 (Osthus), 4,777,750 (Garfinkle), 5,220,740 (Brault), 5,875,578 (Grewe), 5,878,518 (Grewe), and 7,140,581 (White) disclose a variety of portable stands that were designed for the specific purpose of supporting one or more signs. Some variations have wheels to enhance portability, as well as hollow bases that can be filled with water or sand to provide additional weight and better stability.

While the referenced stands are suitable for a specific purpose, they were not designed to be readily modified or reconfigured for multipurpose use, as compared to the present invention.

The portable stand is specifically designed to be used with standard 2-inch diameter polyvinyl chloride (PVC) pipe and fittings that can be configured to accommodate a number of general purpose uses, some of which are described herewith.

### SUMMARY OF THE INVENTION

The original object of the invention was to provide a convenient way to hang and display clothing items during a yard sale. For this application, two portable stands were used to support a clothes rack that can be easily disassembled and stored for re-use.

It is another object of the invention to provide a temporary stand for a mailbox that has been knocked over or otherwise damaged, until a permanent replacement can be installed. Accordingly, the stand's hollow shell can be filled with sand when needed to provide additional weight and enhanced stability for this and other outdoor applications.

It is another object of the invention to provide a portable stand for a bird feeder and/or hanging plants that can be placed in various landscape settings to provide hours of viewing enjoyment.

It is another specific object of the invention to provide a stand for traffic control signs that can be placed at desired locations (temporary or permanent) on a parking lot outside a commercial or industrial facility.

It is another specific object of the invention to provide a stand for traffic control signs inside a commercial or industrial facility at locations (temporary or permanent) where it is not otherwise possible or practical to use rigid floor-mounted, ceiling-mounted, or column-mounted devices.

It is another object of the invention to provide a stand for the purpose of displaying signs in residential areas to advertise yard sales, open houses, items for sale, and the like.

The overall object of the invention is to provide a stand for the specific objects previously listed as well as other general purpose uses.

The general and non-specific accomplishment of the invention objects is embodied in the basic configuration illustrated in the accompanying drawings. It is important to point out that the drawings are submitted to depict the invention as a portable stand or base that is designed to accommodate a myriad of general purpose uses. Variations of invention usage and configuration are subject to specific needs and creativity of the user, respectively.

### BRIEF DESCRIPTION OF THE DRAWINGS

The drawings are intended to show the invention for its basic function as a portable stand, and specific elements of the invention are indicated by reference numbers. The drawings are briefly described, as follows:

FIG. 1 depicts a frontal perspective view of the present invention as a portable base or stand, with no attachments or accessories;

FIG. 2 is a frontal cutaway view showing internal components of the invention, with no attachments or accessories;

FIG. 3 is a photo that shows how 2-inch diameter PVC pipe and fittings can be used with the invention to depict specific objects of the invention as previously described herein.

### DETAILED DESCRIPTION OF SPECIFIC EMBODIMENTS

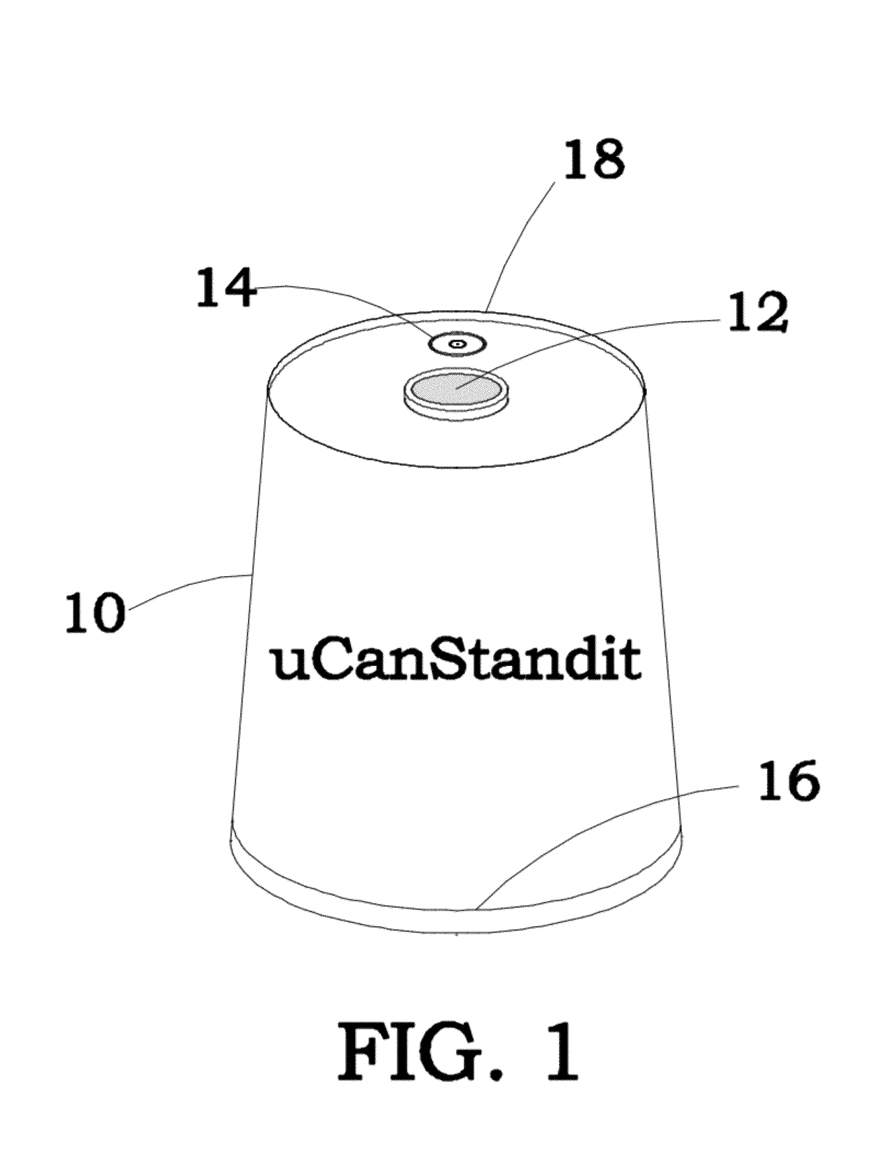

FIG. 1 illustrates a portable stand 10 as the invention object. The portable stand 10 is a hollow plastic shell that has a removable (snap-on/snap-off) base 16. The portable stand 10 is intended to be placed on a flat surface (level ground or floor). In order to enhance stability, the diameter of the circular base 16 is slightly larger than the diameter of the circular top 18.

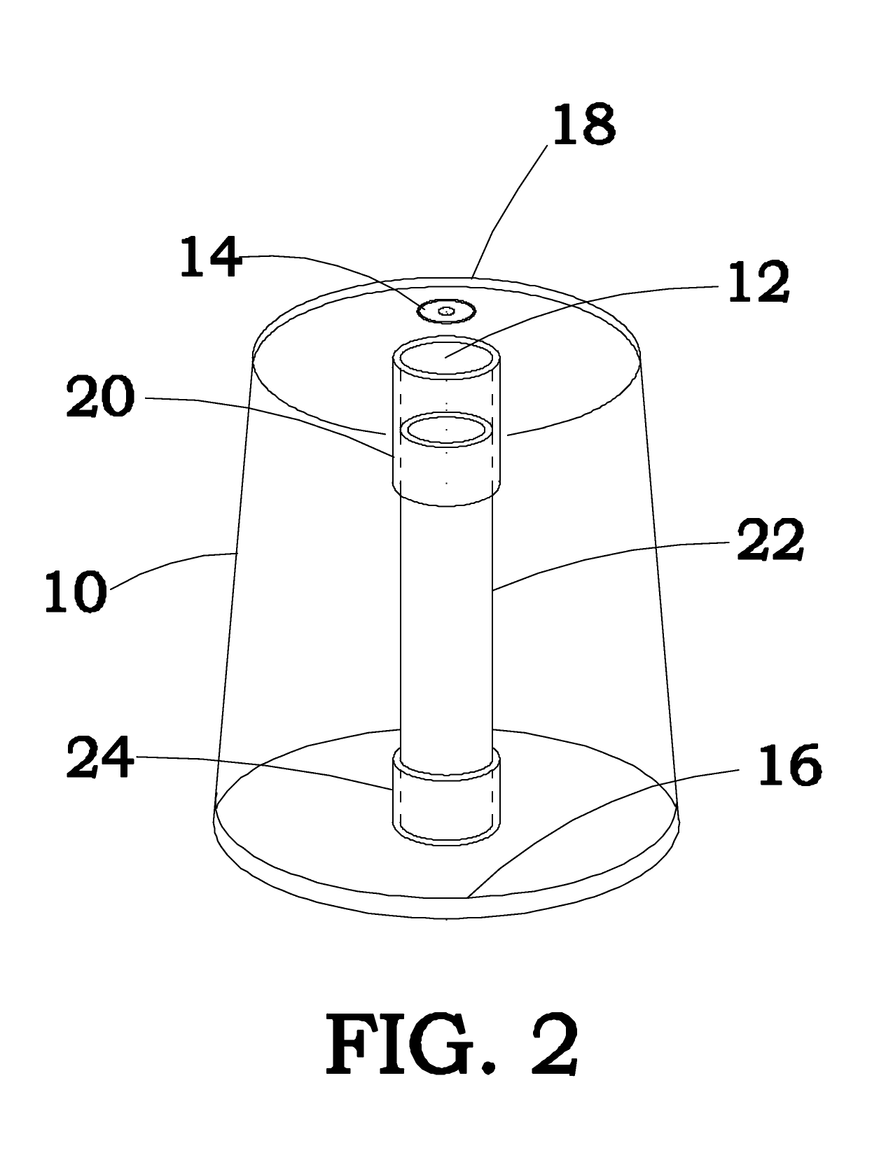

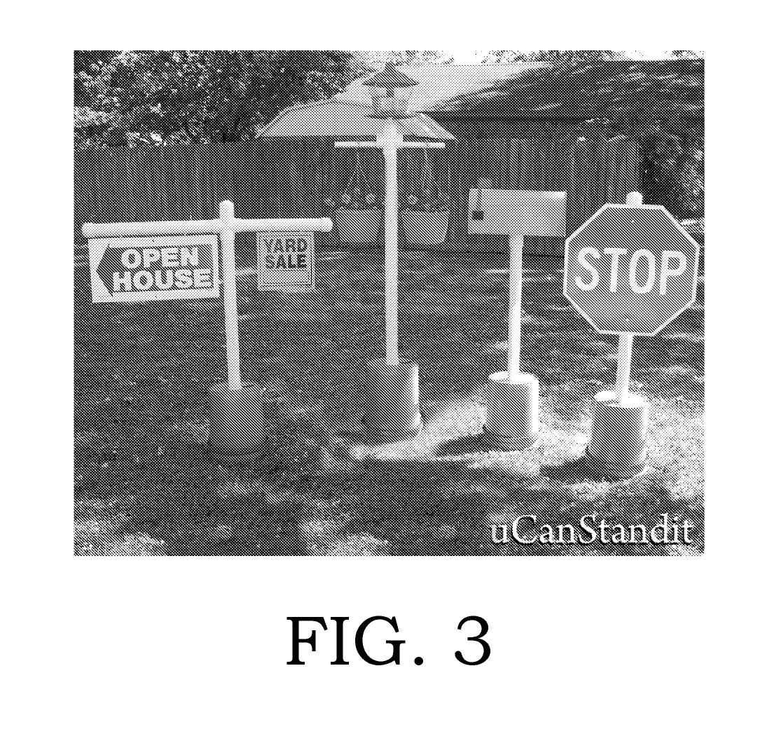

The circular opening 12 shown in the center of the circular top 18 is designed to be a socket for standard 2-inch diameter PVC pipe to serve as a stand-post that is needed to mount and/or display an object of the invention, as depicted in FIG. 3. The structural component that forms the circular opening 12 is depicted and more specifically described in FIG. 2.

Offset from the circular opening 12 in the center of the circular top 18 is a removable plug 14 that is designed to allow the hollow shell to be filled with sand when necessary to provide additional weight and better stability. The removable plug 14 is designed to be removed and replaced, accordingly.

FIG. 2 depicts a cutaway view of the portable stand 10 that shows components inside the hollow shell. Structural component 20 is a standard 2-inch diameter PVC coupling designed to be a socket for a 2-inch diameter PVC pipe stand-post. Structural component 24 is a standard 2-inch diameter PVC cap that is attached to the circular base 16 with standard nut, bolt, and washer components.

Structural component 22 is a section of standard 2-inch diameter PVC pipe. The bottom of the 2-inch diameter PVC pipe 22 is inserted in the 2-inch diameter PVC cap 24. The 2-inch diameter coupling 20 is attached to the top of the 2-inch diameter PVC pipe 22. Components 20, 22, and 24 as assembled and described herein comprise the invention's internal support structure for a 2-inch diameter PVC pipe stand-post.

Stand-post support components 20, 22, 24 are integrally and permanently assembled using standard PVC pipe cement. The top of the stand-post support structure is configured to protrude up, through, and slightly above the invention's circular top 18 to easily and readily facilitate the insertion of a 2-inch diameter PVC pipe stand-post.

FIG. 3 is a photo that shows how standard 2-inch diameter PVC pipe and fittings can be used to configure and accommodate specific objects of the invention as previously described herein.

In conclusion, herein is described a portable stand that is designed to accommodate a number of general purpose uses, as compared to a stand that is designed for a specific use. The invention can accommodate a number of practical uses and configurations subject to specific needs and creativity of the user, respectively. The invention is described in the written description and illustrated in the drawing figures.

What is claimed is:

1. A portable stand that is designed to accommodate a number of general purpose uses when placed on a flat surface (level ground or floor).

2. The portable stand as recited in claim 1, wherein the structure has a circular base that is slightly larger than the circular top to enhance stability, with an integral hollow shell.

3. The portable stand as recited in claim 2, wherein the circular top has an aperture designed to be a socket for a standard 2-inch diameter PVC pipe stand-post and fittings that can be arranged and configured for multipurpose use.

4. The portable stand as recited in claim 3, wherein the circular top also has a removable plug that is designed to allow the hollow shell to be filled with sand when necessary to provide additional weight and better stability. The removable plug is designed to be removed and replaced, accordingly.

5. The portable stand as recited in claim 4, wherein the hollow shell has a stand-post support structure that is designed to hold a 2-inch diameter PVC pipe stand-post securely in an upright position for the intended use.
